(19) United States
(12) Patent Application Publication
(10) Pub. No.: US 2018/0363547 A1
(43) Pub. Date: Dec. 20, 2018

(54) PISTON STROKE ADJUSTMENT APPARATUS FOR INTERNAL COMBUSTION ENGINE

(71) Applicant: HITACHI AUTOMOTIVE SYSTEMS, LTD., Hitachinaka-shi, Ibaraki (JP)

(72) Inventors: Makoto NAKAMURA, Zushi-shi, Kanagawa (JP); Masahiro SHOJI, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/061,087

(22) PCT Filed: Dec. 1, 2016
(86) PCT No.: PCT/JP2016/085698

§ 371 Date: Jun. 11, 2018

(30) Foreign Application Priority Data
Dec. 24, 2015 (JP) 2015-251421

(51) Int. Cl. F02B 75/04; F02D 15/02

(52) U.S. Cl. CPC F02B 75/048; F02D 15/02

(57) ABSTRACT

An object of the present invention is to provide a novel piston stroke adjustment apparatus for an internal combustion engine that can increase a temperature of an air-fuel mixture during a compression stroke to thus improve and stabilize combustion and also can prevent or cut down a reduction in a temperature of exhaust gas during an expansion stroke at the time of a start of the internal combustion engine. According to one aspect of the present invention, the piston stroke adjustment apparatus increases a mechanical compression ratio during the compression stroke to thus increase the temperature of the air-fuel mixture at a compression top dead center, and reduces a mechanical expansion ratio during the expansion stroke to thus prevent or cut down the reduction in the temperature of the exhaust gas at an expansion bottom dead center, at the time of the start of the internal combustion engine. According to this aspect, the piston stroke adjustment apparatus can increase the temperature of the air-fuel mixture at the compression top dead center to thus improve and stabilize the combustion, and also can prevent or cut down the reduction in the temperature of the exhaust gas at the expansion bottom dead center, at the time of the start of the internal combustion engine. Due to this effect, the piston stroke adjustment apparatus allows the internal combustion engine to improve startability thereof and also reduce an exhaust amount of exhaust harmful components.

### TECHNICAL FIELD

The present invention relates to a piston stroke adjustment apparatus for a four-cycle internal combustion engine, and, in particular, to a piston stroke adjustment apparatus for an internal combustion engine that includes a variable mechanism configured to change a position of a top dead center and a position of a bottom dead center of a piston.

### BACKGROUND ART

This type of piston stroke adjustment apparatus for an internal combustion engine has been required to improve various performances of the engine by a combination of control of a variable compression ratio mechanism that variably controls a geometric compression ratio, i.e., a mechanical compression ratio of the internal combustion engine, and control of a variable valve actuating mechanism that variably controls an opening/closing timing of an intake/exhaust valve that determines an actual compression ratio.

A piston stroke adjustment apparats for an internal combustion engine discussed in Japanese Patent Application Public Disclosure No. 2002-276446 (PTL 1) includes the variable valve actuating mechanism for variably controlling the closing timing of the intake valve, and also includes the variable compression ratio mechanism that variably controls the compression ratio.

### CITATION LIST

### Patent Literature

[PTL 1] Japanese Patent Application Public Disclosure No. 2002-276446

### SUMMARY OF INVENTION

### Technical Problem

Then, FIG. 8 in PTL 1 illustrates a posture of the mechanism at a compression top dead center. A left portion in FIG. 8 illustrates a piston position at the compression top dead center in high mechanical compression ratio control (the piston position is slightly high), and a right portion in FIG. 8 illustrates a piston position at the compression top dead center in low mechanical compression ratio control (the piston position is slightly low). Then, focusing on positions at an exhaust (intake) top dead center, the piston positions at the exhaust top dead center coincide with the respective piston positions at the compression top dead center illustrated in FIG. 8 in both the high mechanism compression ratio control and the low mechanical compression ratio control.

This is because the variable compression ratio mechanism discussed in PTL 1 is a mechanism that completes one cycle based on a crank angle of 360 degrees, and therefore the piston position at the compression top dead center and the piston position at the exhaust (intake) top dead center coincide with each other in principle. Further, for the same reason, a piston position at an intake bottom dead center and a piston position at an expansion bottom dead center also coincide with each other. This means that a compression stroke from the piston position at the intake bottom dead center to the piston position at the compression top dead center, and an expansion stroke from the piston position at the compression top dead center to the piston position at the expansion bottom dead center also match each other any time. Therefore, the mechanical compression ratio and the mechanical expansion ratio also match with each other in principle.

Then, the piston stroke adjustment apparatus configured in this manner may cause inconvenience such as an example that will be described below.

For example, an exhaust gas catalyst should be activated quickly (a catalyst conversion rate should be improved or a catalyst warm-up performance should be improved) to improve efficiency of reducing exhaust harmful components by the exhaust gas catalyst at the time of a start of the internal combustion engine. To archive that, it is effective to reduce a mechanical expansion ratio and increase an exhaust temperature. However, the reduction in the mechanical expansion ratio also undesirably causes a reduction in the mechanical compression ratio in a similar manner according thereto, thereby resulting in occurrence of such a phenomenon that a temperature of an air-fuel mixture at the compression top dead center reduces and combustion is deteriorated or loses stability. This raises such a problem that startability of the internal combustion engine is deteriorated or the desired effect of reducing the exhaust harmful components cannot be acquired.

On the other hand, an increase in the mechanical compression ratio contributes to improvement or stabilization of the combustion, but is also undesirably accompanied by an increase in the mechanical expansion ratio in a similar manner according thereto, thereby undesirably leading to a reduction in the temperature of the exhaust gas as large as an increase in expansion work due to the combustion. Therefore, the increase in the mechanical compression ratio results in a reduction in the conversion rate of the exhaust gas catalyst or an increase in a time taken to achieve a high temperature of the exhaust gas catalyst at the time of the start, thereby raising a problem of an increase in a total amount of exhaust harmful components emitted into the atmosphere until the exhaust gas catalyst is activated.

An object of the present invention is to provide a novel piston stroke adjustment apparatus for the internal combustion engine that can increase the temperature of the air-fuel mixture during the compression stroke to thus improve and stabilize the combustion and also can prevent or cut down the reduction in the temperature of the exhaust gas during the expansion stroke at the time when the internal combustion engine is started.

### Solution to Problem

According to one aspect of the present invention, a piston stroke adjustment apparatus increases a mechanical compression ratio during a compression stroke to thus increase a temperature of an air-fuel mixture at a compression top dead center, and reduces a mechanical expansion ratio during an expansion stroke to thus prevent or cut down a reduction in a temperature of exhaust gas at an expansion bottom dead center, at the time of a start of an internal combustion engine.

According to the one aspect of the present invention, at the time when the internal combustion engine is started, the piston stroke adjustment apparatus can increase the temperature of the air-fuel mixture at the compression top dead center to thus improve and stabilize the combustion, and also can prevent or cut down the reduction in the temperature of the exhaust gas at the expansion bottom dead center. Due to this effect, the piston stroke adjustment apparatus allows the internal combustion engine to improve the startability thereof and also reduce the exhaust amount of exhaust harmful components.

### BRIEF DESCRIPTION OF DRAWINGS

FIG. 1 schematically illustrates an entire piston stroke adjustment apparatus according to the present invention.

FIG. 2 is a side view of main portions of the piston stroke adjustment apparatus according to the present invention.

FIG. 3 is a front view of a piston position change mechanism with a front cover of a link posture change mechanism removed therefrom as viewed from an AF direction (a left side).

FIGS. 4(A) to 4(D) illustrate an operation of converting a phase of a control shaft by a piston position change mechanism used in first and second embodiments. FIGS. 4(A) to 4(D) illustrate states when an eccentric rotational phase of the control shaft is controlled to a control phase α1 (for example, 71 degrees), a control phase α2 (for example, 138 degrees), a control phase α3 (for example, 220 degrees), and a control phase α4 (for example, 251 degrees), respectively, at a rotational angle of a crankshaft (X=360 degrees) at which a crankpin faces approximately vertically upward around a compression top dead center.

FIG. 5 illustrates a characteristic indicating changes in a rotational angle of the crankshaft and a height position of a piston according to the first embodiment.

FIGS. 6(A) to 6(H) illustrate an operation of the piston position change mechanism according to the first embodiment. FIGS. 6(A) to 6(D) illustrate piston positions when the eccentric rotational phase of the control shaft is in a maximum advance angle state (the control phase α4), and illustrate an exhaust (intake) top dead center position, an intake bottom dead center position, a compression top dead center position, and an expansion bottom dead center position, respectively. Further, FIGS. 6(E) to 6(H) illustrate piston positions when the eccentric rotational phase of the control shaft is in a maximum retard angle state (the control phase α1), and illustrate states in which the position is the exhaust (intake) top dead center position, the intake bottom dead center position, the compression top dead center position, and the expansion bottom dead center position, respectively.

FIG. 7 is a control flowchart in which control according to the first embodiment is performed.

FIG. 8 illustrates a characteristic indicating changes in the rotational angle of the crankshaft and the height position of the piston according to the second embodiment.

FIGS. 9(A) to 9(H) illustrate an operation of the piston position change mechanism according to the second embodiment. FIGS. 9(A) to 9(D) illustrate piston positions when the eccentric rotational phase of the control shaft is in the maximum advance angle state (the control phase α3) at the time of a start, and illustrate the exhaust (intake) top dead center, the intake bottom dead center position, the compression top dead center position, and the expansion bottom dead center position, respectively. Further, FIGS. 9(E) to 9(H) illustrate piston positions when the eccentric rotational phase of the control shaft is in the maximum retard angle state (the control phase α2) at the time of a start under a high temperature, and illustrate states in which the position is the exhaust (intake) top dead center, the intake bottom dead center position, the compression top dead center position, and the expansion bottom dead center position, respectively.

FIG. 10 is a control flowchart in which control according to the second embodiment is performed.

### DESCRIPTION OF EMBODIMENTS

In the following description, embodiments of the present invention will be described in detail with reference to the drawings, but the present invention is not limited to the embodiments that will be described below and a range thereof also includes various modification examples and application examples within a technical concept of the present invention.

### First Embodiment

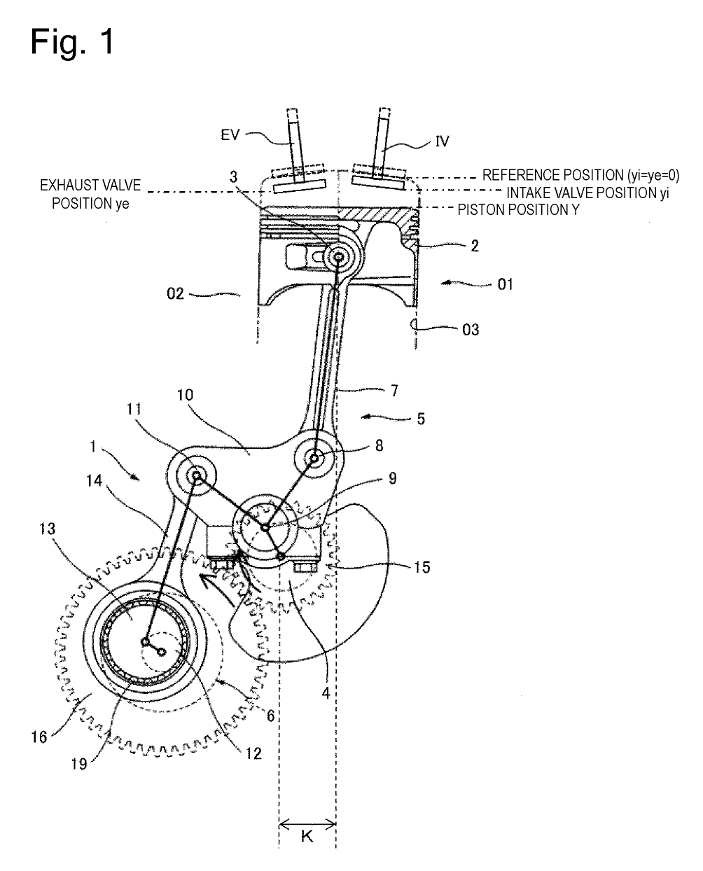

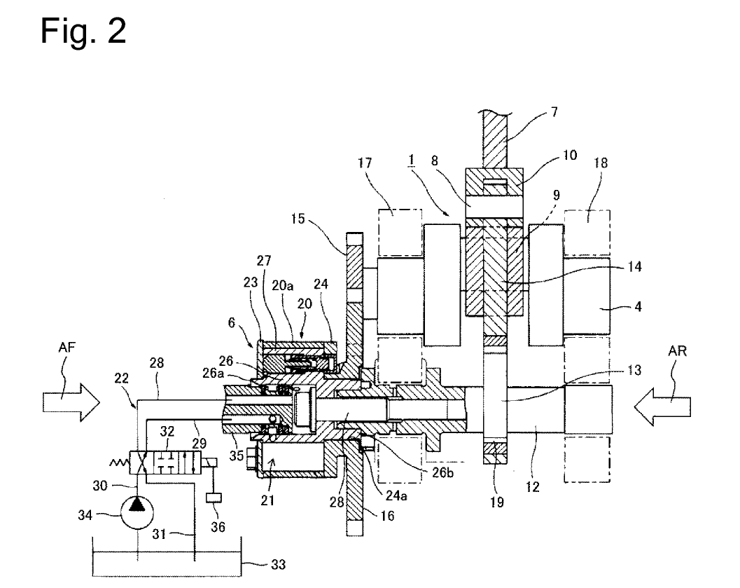

First, a first embodiment of the present invention will be described. FIGS. 1 and 2 schematically illustrate a configuration of a piston stroke adjustment apparatus. Now, FIG. 1 illustrates the piston stroke adjustment apparatus as viewed from a direction AR indicated by an arrow (a right side) in FIG. 2.

An internal combustion engine 01 includes a piston 2 and a crankshaft 4. The piston 2 reciprocates vertically along a cylinder bore 03 formed inside a cylinder block 02. The crankshaft 4 is rotationally driven by the vertical movement of the piston 2 via a piston pin 3 and a link mechanism 5 of a piston position change mechanism 1, which will be described below. A space defined between a crown surface of the piston 2 illustrated in FIG. 1 and a combustion chamber boundary line indicated by an alternate long and short dash line above this crown surface is a cylinder inner volume (a volume in a combustion chamber).

Further, an intake valve IV and an exhaust valve EV are provided in the combustion chamber, and are each opened and closed by a not-illustrated cam shaft. When being lifted toward a piston 2 side (a lower side), these intake valve IV and exhaust valve EV approach the piston crown surface as seen from FIG. 1. Now, a lift amount of the intake valve IV is expressed as a position yi from a reference position (yi=ye=0) in a direction in which the piston slidably moves, and a lift amount of the exhaust valve EV is expressed as a position ye from the reference position in the direction in which the piston slidably moved. Assume that Y represents a position of the piston 2 at this time. The reference position corresponds to a position at which both the intake valve IV and the exhaust valve EV are closed without being lifted. Then, an upward displacement of the piston position Y to the position yi of the intake valve IV or the position ye of the exhaust valve EV at some crank angle leads to occurrence of interference between the piston crown surface and the intake/exhaust valve.

The piston position change mechanism 1 includes the link mechanism 5 including a plurality of links, a link posture change mechanism 6 that changes a posture of the link mechanism 5, and the like. The link mechanism 5 includes an upper link 7, a lower link 10, and a control link 14. The upper link 7 is a first link coupled with the piston 2 via the piston pin 3. The lower link 10 is a second link swingably coupled with the upper link 7 via a first coupling pin 8 and is also rotatably coupled with a crankpin 9 of the crankshaft 4. The control link 14 is a third link swingably coupled with the lower link 10 via a second coupling pin 11 and is also rotatably coupled with an eccentric cam portion 13 of a control shaft 12.

Further, while a small-diameter first gear wheel 15, which is a driving rotational member, is fixed to a front end portion of the crankshaft 4 as illustrated in FIGS. 1 and 2, a large-diameter second gear wheel 16, which is a driven rotational member, is provided on a front end portion side of the control shaft 12, and the piston position change mechanism 1 is configured in such a manner that the first gear wheel 15 and the second gear wheel 16 are meshed with each other to allow a rotational force of the crankshaft 4 to be transmitted to the control shaft 12 via the link posture change mechanism 6.

The first gear wheel 15 has an outer diameter approximately half an outer diameter of the second gear wheel 16, and therefore a rotational speed of the crankshaft 4 is arranged so as to be transmitted to the control shaft 12 while being reduced to a half angler speed due to a difference between the outer diameters of the first gear wheel 15 and the second gear wheel 16. The control shaft 12 is configured in such a manner that a phase thereof relative to the second gear wheel 16 is changed, i.e., a relative rotational phase with respect to the crankshaft 4 is changed by the link posture change mechanism 6.

As illustrated in FIG. 2, the crankshaft 4 and the control shaft 12 are rotatably supported by common two bearing members 17 and 18 provided on the cylinder block in front of and behind them. Further, the eccentric cam portion 13 is rotatably coupled with a large-diameter portion formed at a lower end portion of the control link 14 via a needle bearing 19.

The link posture change mechanism 6 is, for example, configured basically similarly to a hydraulic (vane-type) variable valve actuating mechanism discussed in Japanese Patent Application Public Disclosure No. 2012-225287 previously applied by the present applicant, and will be briefly described now. In the present embodiment, the link posture change mechanism 6 is embodied by the hydraulic link posture change mechanism, but may also be embodied by an electric link posture change mechanism. In this case, the intended function can be achieved by controlling a rotational angle of the control shaft 12 with use of an electric motor.

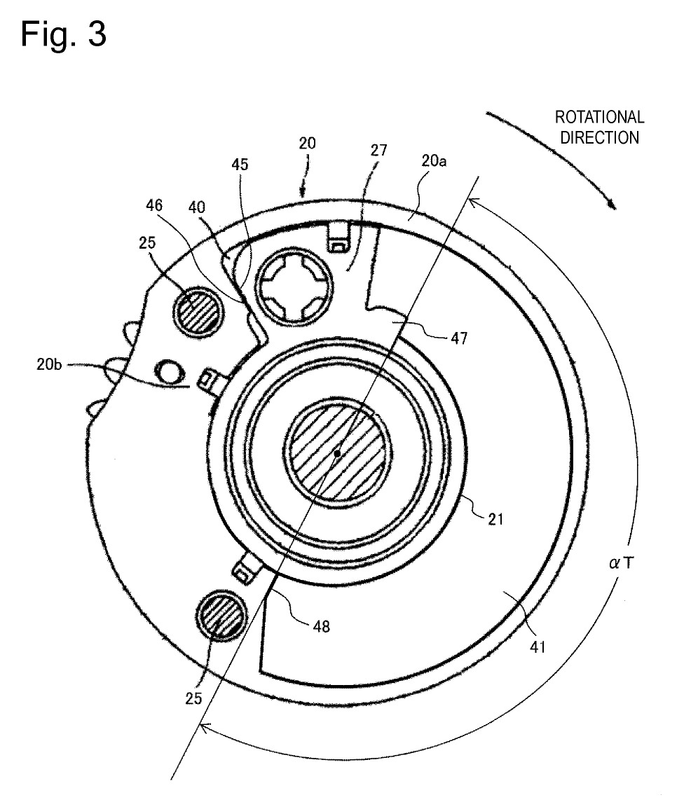

As illustrated in FIGS. 2 and 3, the link posture change mechanism 6 includes a housing 20, a vane rotor 21, and a hydraulic circuit 22. The second gear wheel 16 is fixed to the housing 20. The vane rotor 21 is relatively ratably contained in the housing 20 and fixed to one end portion of the control shaft 12. The hydraulic circuit 22 hydraulically rotates the vane rotor 21 in a normal direction and an opposite direction.

The housing 20 includes a cylindrical housing main body 20a, which is closed at a front end opening thereof by a disk-shaped front cover 23 and is also closed at a rear end opening thereof by a disk-shaped rear cover 24. Further, a wide shoe 20b is formed so as to protrude inward on an inner peripheral surface of the housing main body 20a.

The rear cover 24 is provided at a central position of the second gear wheel 16 integrally with each other, and is fixed at an outer peripheral portion thereof to the housing main body 20a and the front cover 23 by being fastened together therewith with use of bolts 25. Further, a large-diameter bearing hole 24a is formed so as to axially extend through an approximately central portion of the rear cover 24. An outer periphery of a cylindrical portion of the vane rotor 21 is borne by the bearing hole 24a.

The vane rotor 21 includes a cylindrical rotor 26 and one vane 27. The rotor 26 includes a bolt insertion hole at a center thereof. The vane 27 is integrally provided in a circumferential direction of an outer peripheral surface of the rotor 26. The rotor 26 includes a small-diameter cylindrical portion 26a on a front end side thereof, and a small-diameter cylindrical portion 26b on a rear end side thereof. While the small-diameter portion 26a is rotatably supported in a central support hole of the front cover 23, the cylindrical portion 26b is rotatably supported in the bearing hole 24a of the rear cover 24.

Further, the vane rotor 21 is fixed to a front end portion of the control shaft 12 from an axial direction with use of a fixation bolt inserted in the bolt insertion hole of the rotor 26 from the axial direction. Further, the only one vane 27 is arranged on an inner peripheral side of the shoe 20b, and a seal member and a plate spring are each fixedly attached and held in an elongated holding groove formed in an axial direction of an outer surface of the vane 27. The seal member is in sliding contact with an inner peripheral surface of the housing main body 20a. The plate spring presses this seal member in a direction of the inner peripheral surface of the housing main body. Further, an advance angle chamber 40 and a retard angle chamber 41 are individually defined on both sides of this vane 27, respectively, as illustrated in FIG. 3.

As illustrated in FIG. 2, the hydraulic circuit 22 includes hydraulic passages of two systems, a first hydraulic passage 28 and a second hydraulic passage 29. The first hydraulic passage 28 supplies and discharges a hydraulic pressure of hydraulic fluid to and from the advance angle chamber 40. The second hydraulic passage 29 supplies and discharges the hydraulic pressure of the hydraulic fluid to and from the retard angle chamber 41. A supply passage 30 and a drain passage 31 are each connected to both these hydraulic passages 28 and 29 via an electromagnetic switching valve 32 for switching the passage. While a one-way oil pump 34, which pressure-feeds the oil in an oil pan 33, is provided in the supply passage 30, a downstream end of the drain passage 31 is in communication with the oil pan 33.

The first and second hydraulic passages 28 and 29 are formed inside a passage forming portion provided on the front cover 23 side, and, while one end portion of each of them is in communication with inside the above-described rotor 26 via a columnar portion 35 disposed by being inserted in an internal support hole from the small-diameter cylindrical portion 26a of the rotor 26 in the above-described passage forming portion, an opposite end portion is connected to the above-described electromagnetic switching valve 32.

While the first hydraulic passage 28 includes not-illustrated two branch passages in communication with the advance angle chamber 40, the second hydraulic passage 29 includes a second oil passage in communication with the retard angle chamber 41. The electromagnetic switching valve 32 is a four-port three-position type valve, and an internal valve body thereof is configured to perform control of relatively switching each of the hydraulic passages 28 and 29, and the supply passage 30 and the drain passage 31, and is also configured to be switched to be activated according to a control signal from a control unit 36.

Then, the piston position change mechanism 1 is configured to change the relative rotational phase of the vane rotor 21 (the control shaft 12) with respect to the crankshaft 4 by selectively supplying the hydraulic fluid to the advance angle chamber 40 and the retard angle chamber 41 by the switched activation of the electromagnetic switching valve 32. Further, a spring, which constantly biases the vane rotor 21 in a retard angle direction, is attached, although this is not illustrated. This provision speeds up a conversion into a retard angle side.

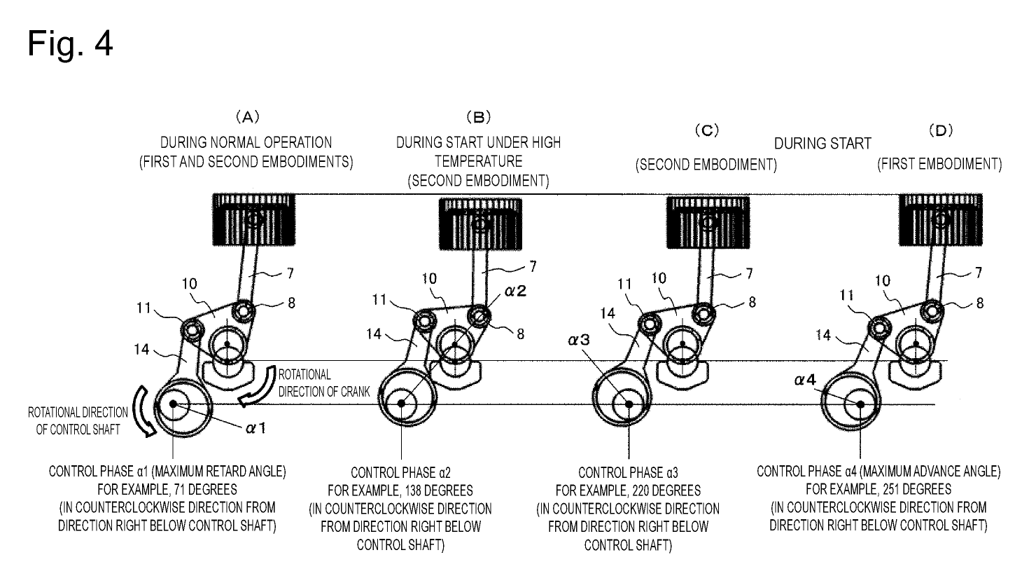

FIGS. 4(A) to 4(D) illustrate the piston position change mechanism 1 when the relative rotational phase between the second gear wheel 16 and the control shaft 12 is changed. In these drawings, the first and second gear wheels 15 and 16 and the like are omitted. In the present embodiment, the piston position change mechanism 1 is configured to be able to change this relative rotational phase by control of converting the relative rotational phase that is performed by the above-described link posture change mechanism 6, but can also change the relative rotational phase by relatively changing an attachment relationship between the above-described second gear wheel 16 and the control shaft 12 (the eccentric cam portion 13).

These drawings, FIGS. 4(A) to 4(D) illustrate postures when the crankshaft 4 is rotated in the clockwise direction without changing the relative phase between the second gear wheel 16 and the crank shaft 12 illustrated in FIG. 1, and is further rotated once from a position at which the crankpin 9 faces vertically upward (the crank angle X=0 degrees and around an exhaust (intake) top dead center) to reach a position at which the crankpin 9 faces vertically upward again (X=360 degrees and around a compression top dead center). In this state, a piston position (height) is located around the compression top dead center, and therefore reaches around a highest position.

In FIG. 4(A), an eccentricity direction of the eccentric cam portion 13 is located at a position changed by, for example, a control phase α1=71 degrees in the counterclockwise direction from a direction right below the control shaft 12. This angular position corresponds to a maximum retard angle state in which the phase is maximally retarded. This position corresponds to a state when the internal combustion engine is normally operated.

Further, in FIG. 4(B), the eccentricity direction of the eccentric cam portion 13 is located at a position changed by, for example, a control phase α2=138 degrees in the counterclockwise direction from the direction right below the control shaft 12. This angular position corresponds to a state in which the phase is advanced by 67 degrees compared to FIG. 4(A). This position corresponds to a state when the internal combustion engine is started under a high temperature according to a second embodiment, which will be described below.

In FIG. 4(C), the eccentricity direction of the eccentric cam portion 13 is located at a position changed by, for example, a control phase α3=220 degrees in the counterclockwise direction from the direction right below the control shaft 12. This corresponds to a state in which the phase is advanced by 149 degrees compared to FIG. 4(A) and further advanced by 82 degrees from FIG. 4(B). This position corresponds to a state as a first example employed at the time of a start (used in the second embodiment).

Further, in FIG. 4(D), the eccentricity direction of the eccentric cam portion 13 is located at a position changed by, for example, a control phase α4=251 degrees in the counterclockwise direction from the direction right below the control shaft 12. This angular position corresponds to a state in which the phase is advanced by 180 degrees compared to FIG. 4(A) and further advanced by 31 degrees from FIG. 4(C). This position corresponds to a state as a second example employed at the time of the start (used in the first embodiment).

In other words, a maximally retarded phase is the control phase α1, and a maximally advanced phase is the control phase α4. Then, intermediate phases therebetween are the control phases α2 and α3. Now, in FIGS. 4(A) to 4(D), the rotational direction of the eccentric cam portion 13 is illustrated as the counterclockwise direction, and therefore the counterclockwise direction is assumed to be an advance angle direction.

As illustrated in FIG. 3, the vane 27 is located at a maximum retard position, i.e., a position corresponding to the position of the above-described control phase α1. In other words, a retard angle-side regulation surface 45 of the vane 27 is placed at a maximum retard angle position in abutment with a retard angle regulation portion 46 on the housing side. At this time, the control shaft 12 fixed to the vane is located at the control phase α1, which is the maximum retard phase.

Then, when the control shaft 12 is rotated by αT (α4−α1) in the advance angle direction (the clockwise direction), an advance angle-side regulation surface 47 of the vane 27 is placed at a maximum advance angle position by abutting an advance angle regulation portion 48 on the housing side. At this time, the control shaft 12 fixed to the vane 27 is located at the control phase α4, which is the maximum advance angle phase.

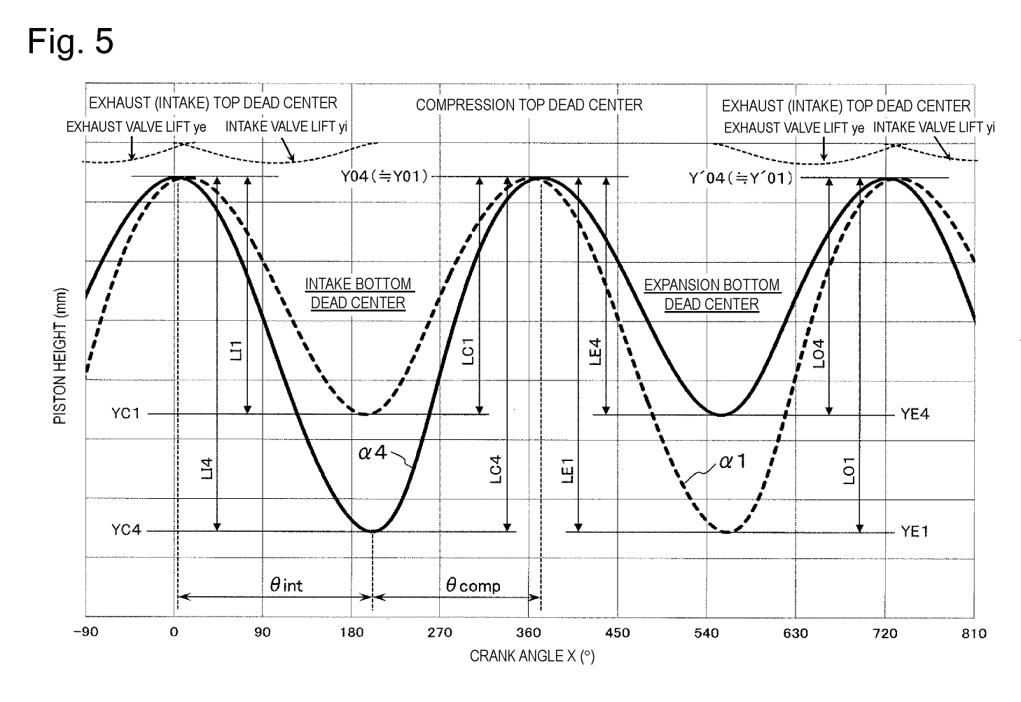

FIG. 5 illustrates a characteristic of a change in the piston position, and illustrates a piston position change characteristic in the control phase at the maximum retard angle (α1) and a piston position change characteristic at the control phase at the maximum advance angle (α4). In FIG. 5, the crankpin 9 is located right above the crankshaft 4 when the crank angle X is 0 degrees, and the piston 2 reaches the exhaust (intake) top dead center around there.

When the crank angle X starts rotating from 0 degrees in the clockwise direction, the exhaust valve EV is completely closed as indicated by an exhaust valve lift curve (ye). Further, an intake lift curve (yi) of the intake valve IV, which has started an opening operation from around 0 degrees, is further increasingly lifted and introduces fresh air (or an air-fuel mixture) from an intake port. Next, the piston 2 reaches an intake bottom dead center around a position where the crank angle X reaches 180 degrees, and the lift of the intake valve IV reduces to only a slight amount around there. Now, a cycle from the intake top dead center to the intake bottom dead center will be referred to as an intake stroke.

When the crankshaft 4 is further rotated, the intake valve IV is completely closed, and the air-fuel mixture in the cylinder is compressed along therewith, and the piston 2 reaches the compression top dead center around a position where the crank angle X reaches 360 degrees (the crankpin 9 reaches the position right above the crankshaft 4 again). Now, a cycle from the intake bottom dead center to the compression top dead center will be referred to a compression stroke.

After that, spark ignition (or compression ignition) is carried out and combustion is started, and the piston 2 is being pressed down by a combustion pressure thereof and reaches an expansion bottom dead center around a position where the crank angle X reaches 540 degrees. Now, a cycle from the compression top dead center to the expansion bottom dead center will be referred to as an expansion stroke.

An opening operation of the exhaust valve EV is started when the piston is located around this expansion bottom dead center. Then, combusted gas (exhaust gas) is emitted from an exhaust port together with a re-rise of the piston 2, and the crank angle X returns again to a position of 720 degrees (=0 degrees) (the crankpin 9 is located right above the crankshaft 4) corresponding to around the exhaust (intake) top dead center. Now, a cycle from the expansion bottom dead center to the exhaust (intake) top dead center will be referred to as an exhaust stroke.

In the above-described manner, the internal combustion engine 01 operates as a four-cycle engine, and periodically operates so as to complete one cycle based on the crank angle (X) of 720 degrees. In PTL 1, the discussed apparatus periodically operates so as to complete one cycle based on the crank angle (X) of 360 degrees, and therefore has low flexibility for the piston stroke characteristic. On the other hand, the present embodiment completes one cycle based on the crank angle (X) of 720 degrees, and therefore allows a mechanical compression ratio and a mechanical expansion ratio to be set differently.

For example, establishing a relationship of the mechanical compression ratio>the mechanical expansion ratio at the time of the start as will be described below can increase a temperature of the air-fuel mixture at the compression top dead center to thus improve and stabilize the combustion, and, further, can prevent or cut down a reduction in a temperature of exhaust gas at the expansion bottom dead center at the time of the start of the internal combustion engine.

In FIG. 5, a thick solid line represents the piston stroke characteristic (a piston crown surface position change characteristic) in the control phase α4 (the maximum advance angle) illustrated in FIG. 4(D), and a thick broken line represents the piston stroke characteristic (a piston crown surface position change characteristic) in the control phase α1 (the maximum retard angle) illustrated in FIG. 4(A).

Now, the control phase α1 is a control phase used in the normal operation state of the internal combustion engine as illustrated in FIGS. 4(A) to 4(D) by way of example, and the control phase α4 is a control phase used in the start state of the internal combustion engine as illustrated in FIGS. 4(A) to 4(D) by way of example.

Focusing on the piston position at the compression top dead center, a piston position (Y01) in the control phase α1 indicated by the broken line is located at a relatively high position, and a piston position (Y04) in the control phase α4 indicated by the solid line is also located at approximately the same position. Then, piston positions (Y′01) and (Y′04) at the exhaust (intake) top dead center are also located at approximately the same position. Then, as a cylinder inner volume (V0) at the compression top dead center, the combustion chamber has cylinder inner volumes (V01) and (V04) respectively corresponding to the above-described compression top dead center positions. Then, the piston positions at the compression top dead center are located at approximately the same height, which means that the cylinder inner volume (V0) has a relationship V01≅V04 (V01 is approximately equal to V04).

Now, this cylinder inner volume V0 refers to a volume surrounded by a shape of an inner surface of the combustion chamber on the cylinder head side, a shape of the crown surface 2a of the piston 2, an inner diameter of the cylinder block 02, an inner diameter of a not-illustrated head gasket, and the like at the compression top dead center, i.e., a volume occupied by gas (the air-fuel mixture) at the compression top dead center.

On the other hand, in FIG. 5, focusing on a piston position at the intake bottom dead center, a piston position (YC1) in the control phase α1 indicated by the broken line, and a piston position (YC4) in the control phase α4 indicated by the solid line are considerably different from each other. The piston position (YC4) in the control phase α4 indicated by the solid line is located at an extremely lower position than the piston position (YC1) in the control phase α1 indicated by the broken line. Therefore, a compression stroke (LC), which is a length from the compression top dead center to the intake bottom dead center, has the following relationship. A compression stroke (LC1) in the control phase α1 and a compression stroke (LC4) in the control phase α4 have a relationship LC1<<LC4 therebetween. An intake stroke (LI1) in the control phase α1 and an intake stroke (LI4) in the control phase α4 also have a relationship LI1<<LI4 therebetween.

Similarly, focusing on a piston position at the expansion bottom dead center, a piston position (YE1) in the control phase α1 indicated by the broken line, and a piston position (YE4) in the control phase α4 indicated by the solid line are considerably different from each other. The piston position (YE1) in the control phase α1 is located at an extremely lower position than the piston position (YE4) in the control phase α4. Therefore, a length of an expansion stroke (LE), which is a length from the compression top dead center to the expansion bottom dead center, is also considerably different. Due to that, the expansion stroke (LE1) in the control phase α1 and the expansion stroke (LE4) in the control phase α4 have a relationship LE1>>LE4 therebetween. An exhaust stroke (LO1) in the control phase α1 and an exhaust stroke (LO4) in the control phase α4 also have a relationship LO1>>LO4 therebetween.

From these relationships, the following result is yielded when a relationship between the compression stroke (LC1) and the expansion stroke (LE1) in the control phase α1, and a relationship between the compression stroke (LC4) and the expansion stroke (LE4) in the control phase α4 are compared to each other. A relationship LE1>>LC1 is established in the control phase α1 used in the normal operation state, and a relationship LE4<<LC4 is established in the control phase α4 used in the start state.

Now, a mechanical compression ratio (C1), which is a mechanical compression ratio in the control phase α1, and a mechanical expansion ratio (E1), which is a mechanical expansion ratio in the same control phase α1, will be discussed.

Assuming that S represents an area of a bore (a cylinder inner diameter), a cylinder inner volume VC1 at the intake bottom dead center is expressed as VC1=V01+S×LC1. Therefore, the mechanical compression ratio (C1) is expressed as C1=VC1÷V01=(V01+S×LC1)÷V01=1+S×LC1÷V01.

On the other hand, a cylinder inner volume VE1 at the expansion bottom dead center is expressed as VE1=V01+S×LE1. Therefore, the mechanical expansion ratio E1 is expressed as E1=VE1÷V01=(V01+S×LE1)÷V01=1+S×LE1÷V01.

Therefore, in the case of the control phase α1, since the stroke relationship is LE1>>LC1 as illustrated in FIG. 5, the mechanical compression and expansion ratios have a relationship of the mechanical expansion ratio (E1)>the mechanical compression ratio (C1) therebetween. Now, assuming that a relative ratio D is defined to be D=the mechanical expansion ratio E÷the mechanical compression ratio C, a relative ratio D1 is determined to be D1=E1÷C1>1 in the case of the control phase α1.

Similarly, a mechanical compression ratio (C4), which is a mechanical compression ratio in the control phase α4, and a mechanical expansion ratio (E4), which is a mechanical expansion ratio in the same control phase α4, will be discussed.

A cylinder internal volume VC4 at the intake bottom dead center is expressed as VC4=V04+S×LC4. Therefore, the mechanical compression ratio C4 is expressed as C4=VC4 V04=(V04+S×LC4)÷V04=1+S×LC4÷V04. On the other hand, a cylinder inner volume VE4 at the expansion bottom dead center is expressed as VE4=V04+S×LE4. Therefore, the mechanical expansion ratio E4 is expressed as E4=VE4÷V04=(V04+S×LE4)÷V04=1+S×LE4÷V04.

Therefore, in the case of the control phase α4, since the stroke relationship is LE4<<LC4 as illustrated in FIG. 5, the mechanical compression and expansion ratios have a relationship of the mechanical expansion ratio (E4)<the mechanical compression ratio (C4) therebetween. Since the relative ratio D is D=the mechanical expansion ratio E÷the mechanical compression ratio C, a relative ratio D4 is determined to be D4=E4÷C4<1 in the case of the control phase α4.

The control phase α1 is used in the normal operation state and the control phase α4 is used in the start state, and, next, specific functions and effects of them will be described.

As described above, the cylinder inner volume (V01) in the control phase α1 and the cylinder inner volume (V04) in the control phase α4 have the relationship V01 V04 therebetween. Then, the compression stroke (LC) has the relationship LC1<<LC4, and the expansion stroke (LE) has the relationship LE1>>LE4.

Further, in the case of the control phase α1, since the stroke relationship is LE1>>LC1, the mechanical compression and expansion ratios have the relationship of the mechanical expansion ratio (E1)>the mechanical compression ratio (C1) therebetween. Further, in the case of the control phase α4, since the stroke relationship is LE4<<LC4, the mechanical compression and expansion ratios have a relationship of the mechanical expansion ratio (E4)<the mechanical compression ratio (C4) therebetween.

Now, a characteristic of the control phase α1 can be said to be a characteristic suitable for the normal operation state after the internal combustion engine is warmed up. More specifically, the control phase α1 has the extremely high mechanical expansion ratio (E1), thereby realizing large expansion work and thus bringing about an effect of improving thermal efficiency and improving a fuel efficiency performance.

Further, the control phase α1 has the mechanical compression ratio (C1) that is not excessively high, thereby succeeding in a reduction in a gas temperature in the cylinder at the compression top dead center. For this reason, the control phase α1 prevents or cuts down an excessive increase in the temperature of the air-fuel mixture in the cylinder at the compression top dead center to thus prevent or cut down an increase in a cooling loss, thereby contributing to improvement of the thermal efficiency (the fuel efficiency performance), and further, prevents or reduces abnormal combustion called knocking, thereby achieving stabilization of the combustion of the internal combustion engine.

On the other hand, a characteristic of the control phase α4 can be said to be a characteristic suitable for the start state before the internal combustion engine is warmed up. More specifically, the control phase α4 has the extremely high mechanical compression ratio (C4), thereby succeeding in an increase in the temperature of the air-fuel mixture in the cylinder at the compression top dead center even at the time of the start before the warm-up. Due to this effect, the control phase α4 can realize excellent combustion to thus improve the startability even at the time of the start when the combustion is likely to be deteriorated, thereby preventing or reducing emission of the exhaust harmful components from a main body of the internal combustion engine.

Further, as illustrated in FIG. 5, an intake period θint (a period from the exhaust top dead center to the intake bottom dead center/the crank angle) is relatively long compared to a compression period θcomp (a period from the intake bottom dead center to the compression top dead center/the crank angle). Therefore, the control phase α4 allows fresh air (the air-fuel mixture) to be sufficiently introduced, thereby contributing to a sufficient increase in a start combustion torque required for the start even at the time of the start when the internal combustion engine has high mechanical friction resistance.

Further, the compression period θcomp is relatively short compared to the intake period θint. Therefore, the control phase α4 can reduce a thermal amount released into the cylinder in the course of the rise of the piston 2 toward the compression top dead center and the increase in the temperature of the air-fuel mixture in the cylinder, thereby further increasing the temperature of the air-fuel mixture at the compression top dead center. This effect allows the internal combustion engine to further improve the combustion to thus enhance the start combustion torque, thereby improving the startability.

Further, according to the characteristic of the control phase α4, the mechanical expansion ratio (E4) is set to a lower ratio than the mechanical compression ratio (C4), and therefore the following functions and advantageous effects can be brought about. That is, the relatively low mechanical expansion ratio (E4) means a reduction in the expansion work of the combustion gas and an increase in the temperature of the exhaust gas emitted from the internal combustion engine according thereto. Therefore, the control phase α4 allows high-temperature exhaust gas to be supplied to an exhaust gas catalyst at the time of the start, thereby improving a conversion rate of the exhaust gas catalyst and achieving a reduction in the exhaust harmful components discharged into the atmosphere.

Further, the control phase α4 can quickly increase a temperature of the exhaust gas catalyst due to this high temperature of the exhaust gas. Due to this effect, the control phase α4 reduces a time taken until the exhaust gas catalyst is activated, thereby contributing to a reduction in a total amount of exhaust harmful components emitted into the atmosphere.

In this manner, according to the characteristic of the control phase α4, increasing the mechanical compression ratio at the time of the start of the internal combustion engine leads to the increase in the temperature of the air-fuel mixture at the compression top dead center to thus achieve the improvement and stabilization of the combustion, thereby contributing to the reduction in the exhaust gas harmful components emitted from the internal combustion engine itself.

Further, reducing the mechanical expansion ratio at the time of the start of the internal combustion engine can prevent or cut down the reduction in the temperature of the exhaust gas at the expansion bottom dead center, thereby allowing the high-temperature exhaust gas to be supplied to the exhaust gas catalyst. Due to this effect, the conversion rate of the exhaust gas catalyst can be improved, and warm-up of the exhaust gas catalyst further can be facilitated. In this manner, the startability of the internal combustion engine can be improved and the emission amount of exhaust harmful components can be reduced.

Then, the increase in the mechanical compression ratio (C4) can realize the excellent combustion to thus improve the startability as described above, and this effect can also lead to improvement of combustion resistance to thus allow an ignition timing to be retarded. In this case, a combustion center phase is also retarded, and therefore the internal combustion engine becomes able to also increase the temperature of the exhaust gas. This results in a further addition to the effect of increasing the temperature of the exhaust gas due to the reduction in the mechanical expansion ratio (E4), thereby allowing the internal combustion engine to further increase the temperature of the exhaust gas to further enhance the conversion performance of the catalyst.

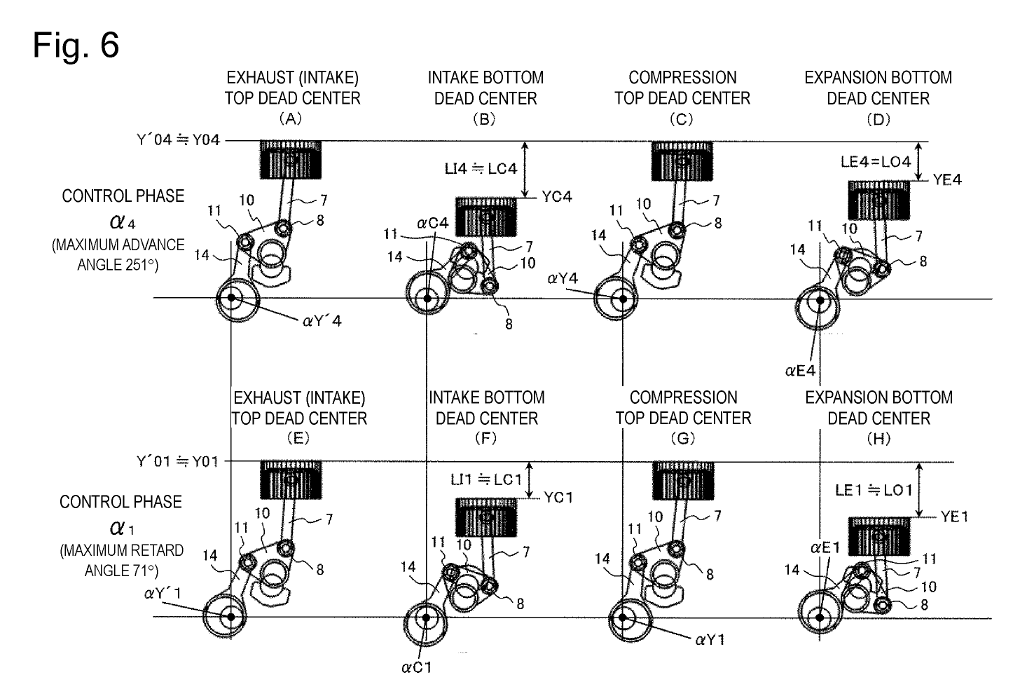

Next, a change in a mechanism posture in each stroke of a combustion cycle in each of the control phase α1 and the control phase αb4 will be described with reference to FIGS. 6(A) to 6(H). This description will be able to make the characteristic of the change in the piston position illustrated in FIG. 5 further easily understandable. FIGS. 6(A) to 6(D) lined up in an upper row illustrate the change in the mechanism posture in the control phase α4 (the maximum advance angle state), and FIGS. 6(E) to 6(H) lined up in a lower row illustrate the change in the mechanism posture in the control phase α1 (the maximum retard angle state).

<<Exhaust (Intake) Top Dead Center>>

First, the change in the mechanical posture will be discussed, focusing on an eccentricity direction (αY′) of the eccentric cam portion at the exhaust (intake) top dead center. In the control phase α1, as illustrated in FIG. 6(E), an eccentricity direction (αY′1) of the eccentric cam portion is oriented to the left side around an intermediate position between a direction of the control link 14 and a direction extending toward an opposite side therefrom.

On the other hand, in the control phase α4, as illustrated in FIG. 6(A), an eccentricity direction (αY′4) of the eccentric cam portion is oriented to the right side (a symmetrically opposite relationship) around the intermediate position between the direction of the control link 14 and the direction extending toward the opposite side therefrom.

Therefore, the control link 14 is pulled down by approximately the same amount between the control phase α1 and the control phase α4, as a result of which an exhaust (intake) top dead center position (Y′01) in the control phase α1 and an exhaust (intake) top dead center position (Y′04) in the control phase α4 are placed at approximately the same position.

<<Intake Bottom Dead Center>>

Next, the change in the mechanical posture will be discussed, focusing on an eccentricity direction (αC) of the eccentric cam portion at the intake bottom dead center. In the control phase α1, as illustrated in FIG. 6(F), an eccentricity direction (αC1) of the eccentric cam portion is oriented in the opposite direction from the control link 14. Due to this posture, the control link 14 pulls down the second coupling pin 11 to the lower left, and the lower link 10 is rotated in the counterclockwise direction with the crankpin serving as a supporting point therefor. Due to this movement, the position of the first coupling pin 8 is raised, and thus the piston 2 is pushed up by the upper link 7. As a result, the intake bottom dead center (YC1), which corresponds to a compression start point, is placed at a relatively high position, and a short compression stroke (LC1) is acquired at this time.

On the other hand, in the control phase α4, as illustrated in FIG. 6(B), an eccentricity direction (αC4) of the eccentricity control cam is oriented in the direction of the control link 14. Due to this posture, the control link 14 pushes up the second coupling pin 11 to the upper right, and the lower link 10 is rotated in the clockwise direction with the crankpin serving as a supporting point therefor. Due to this movement, the position of the first coupling pin 8 is lowered, and thus the piston 2 is pulled down by the upper link 7. As a result, the intake bottom dead center (YC4), which also corresponds to the compression start point, is placed at a relatively low position compared to the control phase α1, and a long compression stroke (LC4) is acquired at this time. This causes the compression stroke (LC) to have the relationship “LC1<<LC4”.

<<Compression Top Dead Center>>

Next, the change in the mechanical posture will be discussed, focusing on an eccentricity direction (αY) of the eccentric cam portion at the compression top dead center. In the control phase α1, as illustrated in FIG. 6(G), an eccentricity direction (αY1) of the eccentric cam portion is oriented to the right side around the intermediate position between the direction of the control link 14 and the direction extending toward the opposite side therefrom.

On the other hand, in the control phase α4, as illustrated in FIG. 6(C), an eccentricity direction (αY4) of the eccentric cam portion is oriented to the left side (a symmetrically opposite relationship) around the intermediate position between the direction of the control link 14 and the direction extending toward the opposite side therefrom.

Therefore, the control link 14 is pulled down by approximately the same amount between the control phase α1 and the control phase α4, as a result of which the compression top dead center position (Y01) in the control phase α1 and the compression top dead center position (Y04) in the control phase α4 are placed at approximately the same position.

Then, the link posture is approximately the same between the exhaust (intake) top dead center in the control phase α1 and the compression top dead center in the control phase α4, and, further, the link posture is approximately the same between the exhaust (intake) top dead center in the control phase α4 and the compression top dead center in the control phase α1. Therefore, as illustrated in FIG. 5, a characteristic “Y01≅Y′01≅Y04≅Y′04” is established.

<<Expansion Bottom Dead Center>>

Next, the change in the mechanical posture will be discussed, focusing on an eccentricity direction (αE) of the eccentric cam portion at the expansion bottom dead center. In the control phase α1, as illustrated in FIG. 6(H), an eccentricity direction (αE1) of the eccentric cam portion is oriented in the direction of the control link 14. Due to this posture, the control link 14 pushes up the second coupling pin 11 to the upper right, and the lower link 10 is rotated in the clockwise direction with the crankpin serving as a supporting point therefor, by which the position of the first coupling pin 8 is lowered and the piston is pulled down by the upper link 7. As a result, an expansion bottom dead center (YE1) is placed at a relatively low position, and a long expansion stroke (LE1) is acquired at this time.

On the other hand, an eccentricity direction (αE4) of the eccentricity control cam is oriented in the opposite side from the direction of the control link 14. Due to this posture, the control link 14 pushes down the second coupling pin 11 to the lower left, and the lower link 10 is rotated in the counterclockwise direction with the crankpin serving as a supporting point therefor, by which the position of the first coupling pin 8 is raised and thus the piston is pushed up by the upper link 7. As a result, an expansion bottom dead center (YE4) is placed at a relatively high position, and a short expansion stroke (LE4) is acquired at this time. This causes the expansion stroke (LE) to have the relationship “LE1>>LE4”.

In this manner, the characteristic illustrated in FIG. 5 is established, as the control phase α1 has the relationship “YC1>YE1” and the control phase α4 has the relationship “YE4>YC4”.

Next, a reason why the control phase α4 illustrated in FIG. 5 exhibits θint>θcomp will be described with reference to FIGS. 6(A) to (H).

In the control phase α4, as illustrated in FIG. 6(A), the crankpin indicated at the exhaust (intake) top dead center faces approximately vertically upward. Then, the piston reaches the intake bottom dead center position (YC4) illustrated in FIG. 6(B) around when the crankshaft is rotated by approximately 180 degrees in the clockwise direction, but, in the posture at the exact intake bottom dead center position (YC4), the piston reaches the intake bottom dead center when the crankshaft is rotated to a position beyond 180 degrees by some degrees as illustrated in FIG. 6(B).

Now, the crankpin itself reaches a lowermost position when the crankshaft is rotated exactly by 180 degrees, but the lower link 10 is noticeably inclined in the clockwise direction around a position exceeding 180 degrees to some extent, in other words, a position according to a phase retarded in terms of a crank angle phase to some extent, i.e., a position to which the crankpin is slightly moved leftward. Therefore, the upper link 7 further pulls down the piston, and the intake bottom dead center position (YC4) is set according to the phase delayed in terms of the crank angle phase.

At this time, the phenomenon that the lower link 10 is inclined in the clockwise direction is a phenomenon caused by the leftward movement of the crankpin with the eccentricity control cam pulling down the second coupling pin 11 via the control link 14, and likely occurs especially when the second coupling pin 11 of the lower link 10 is located at a high position like the present embodiment.

Then, such a phenomenon likely occurs (occurs to a noticeable degree) when the piston is located around the intake bottom dead center. Conversely, such a phenomenon is not noticeable when the piston is located around the exhaust (intake) top dead center, and the top dead center phase is determined mainly based on the phase of the crankpin.

In other words, the position at the exhaust top dead center corresponds to the crank phase in which the crankpin is located around the position approximately right above the crankshaft 4, and the position at the intake bottom dead center corresponds to the crank phase in which the crankpin is rotated by some degrees from the position right below the crankshaft 4. For this reason, the relationship θint>θcomp is established.

In this manner, the piston position change characteristics in the control phase α1 and the control phase α4 illustrated in FIG. 5 are created based on the difference in the link posture due to the difference in the eccentricity phase of the control cam illustrated in FIGS. 6(A) to 6(H).

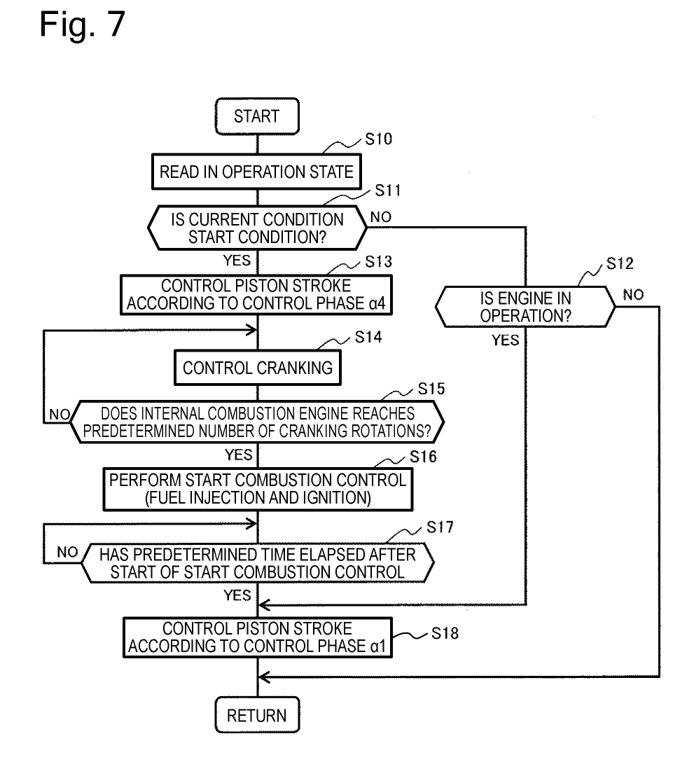

Next, specific control corresponding to the operation state using the above-described piston stroke adjustment apparatus will be described with reference to FIG. 7. FIG. 7 illustrates a specific control flowchart thereof.

First, in step S10, the piston stroke adjustment apparatus reads in various kinds of operation information including the start state as a current operation state of the engine. Next, in step S11, the piston stroke adjustment apparatus determines whether the current condition is a start condition. The start condition can be determined from a driver's key switch operation, pressing of an accelerator, or the like.

If determining that the current state is not the start state (the start condition) in step S11, in step S12, the piston stroke adjustment apparatus determines whether the internal combustion engine is in operation. If the piston stroke adjustment apparatus determines that the internal combustion engine is not in operation, the processing proceeds to RETURN and this control is ended. On the other hand, if determining that the internal combustion engine is in operation, the piston stroke adjustment apparatus determines that the current state is the normal operation state after the warm-up is ended. Then, the processing proceeds to step S18, in which the piston stroke adjustment apparatus adjusts (controls) the piston stroke according to the control phase α1.

If the piston stroke adjustment apparatus determines that the current state is the start state in step S11, the processing proceeds to step S13, in which the piston stroke adjustment apparatus adjusts the piston stroke according to the control phase α4 suitable for the start. Upon an end of the setting of the control phase α4 in step S13, in step S14, the piston stroke adjustment apparatus cranks and starts the internal combustion engine. After that, the processing proceeds to step S15, in which the piston stroke adjustment apparatus determines whether the internal combustion engine reaches a predetermined number of cranking rotations. If the internal combustion engine does not reach the predetermined number of cranking rotations, the processing returns to step S14 again, in which the piston stroke adjustment apparatus continues the cranking. If the internal combustion engine exceeds the predetermined number of cranking rotations, the processing proceeds to step S16.

In step S16, the piston stroke adjustment apparatus performs start combustion control such as fuel injection control and ignition control. After that, the processing proceeds to step S17. In step S17, the piston stroke adjustment apparatus determines whether a predetermined time has elapsed from the start of the start combustion control. This determination is a determination about whether the internal combustion engine is warmed up. If the predetermined time has not elapsed, the piston stroke adjustment apparatus performs this determination processing again. If the predetermined time has elapsed, the piston stroke adjustment apparatus determines that the internal combustion engine is warmed up, and then the processing proceeds to step S18.

Step S18 is set in such a manner that the piston stroke adjustment apparatus switches the control from control according to the control phase α4 to control according to the control phase α1, thus performing control for the normal operation state, and then the processing proceeds to RETURN.

In the above-described manner, in the present embodiment, the piston stroke adjustment apparatus is configured to increase the mechanical compression ratio during the compression process to increase the temperature of the air-fuel mixture at the compression top dead center to thus improve the combustion while reducing the mechanical expansion ratio during the expansion stroke to prevent or cut down the reduction in the temperature of the exhaust gas at the expansion bottom dead center, at the time of the start of the internal combustion engine.

According to this configuration, the piston stroke adjustment apparatus can increase the temperature of the air-fuel mixture at the compression top dead center to thus improve and stabilize the combustion, and, further, can prevent or cut down the reduction in the temperature of the exhaust gas at the expansion bottom dead center, at the time of the start of the internal combustion engine. Due to this effect, the piston stroke adjustment apparatus allows the internal combustion engine to improve the startability thereof and also reduce the exhaust amount of exhaust harmful components. Further, the piston stroke adjustment apparatus also allows the internal combustion engine to retard the ignition timing according to the improvement of the combustion resistance due to the above-described effect of increasing the temperature of the air-fuel mixture at the compression top dead center. In this case, the combustion center phase is also retarded, and therefore the piston stroke adjustment apparatus allows the internal combustion engine to also increase the temperature of the exhaust gas. As a result, the piston stroke adjustment apparatus also allows the internal combustion engine to further increase the conversion performance of the catalyst, thereby further enhancing the above-described effect of reducing the emission amount of the exhaust harmful components.

### Second Embodiment

Next, a second embodiment of the present invention will be described. The second embodiment aims at acquiring an effect of further reducing the exhaust gas harmful components by controlling the phase of the control shaft to a control phase α3 (for example, 220 degrees) illustrated in FIG. 4. Further, the second embodiment is an embodiment that also employs a control phase α2 for preventing or reducing occurrence of pre-ignition at the time of a restart under a high engine temperature.

A maximum retard angle phase according to the present embodiment is the control phase α1 (for example, 71 degrees) similarly to the first embodiment, but a maximum advance angle phase is the control phase α3 (for example, 220 degrees). Therefore, a conversion angle αT illustrated in FIG. 3 is set so as to reduce to, for example, 149 degrees (α3−α1). In other words, the conversion angle αT is set in such a manner that a position engaged at the maximum advance angle corresponds to the control phase α3.

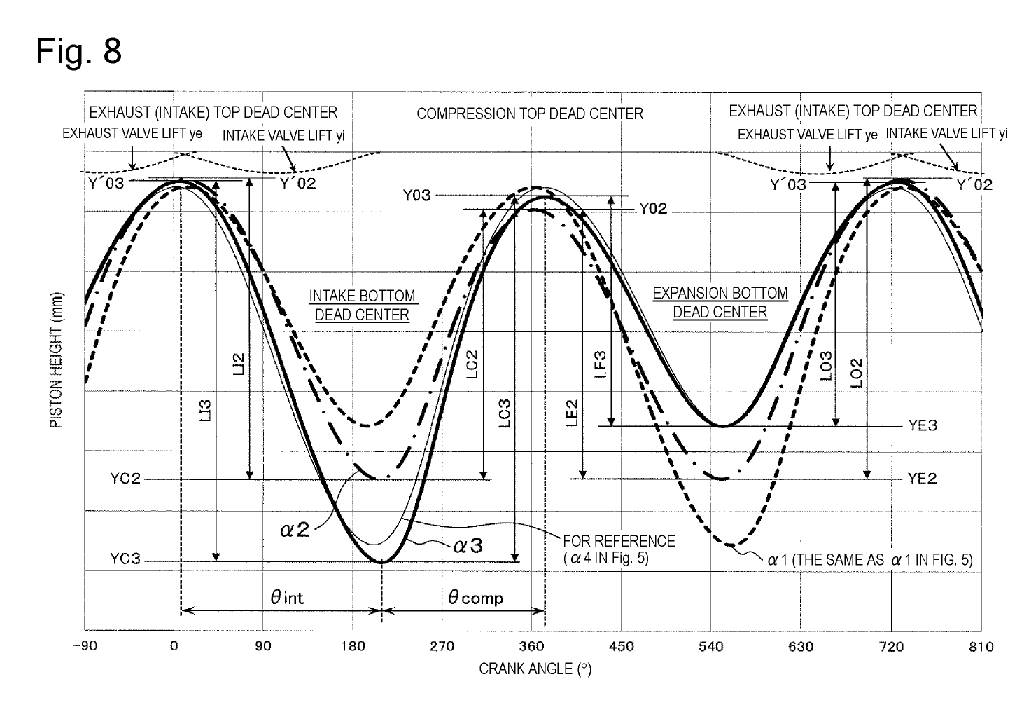

Then, a piston position change characteristic according to the present embodiment is illustrated in FIG. 8, but is basically similar to the characteristic illustrated in FIG. 5. The characteristic of the control phase α1 is similar to the first embodiment, and therefore a description thereof will be omitted here. Further, the characteristic of the control phase α4 is also indicated by a thin solid line, but this is not used in the present embodiment and is illustrated only for a comparison with the first embodiment.

Then, a characteristic of the control phase α3 used in the present embodiment at the time of the start is indicated by a thick solid line, and a characteristic of the control phase α2 used at the time of the start under the high temperature when the internal combustion engine is in a high-temperature state is indicated by a thick alternate long and short dash line.

First, the characteristic of the control phase α3 used at the time of the start will be discussed. Similarly to the characteristic of the control phase α4 according to the first embodiment, this characteristic has an intake bottom dead center position (YC3) considerably lowered compared to an expansion bottom dead center (YE3), and exhibits a relationship of a mechanical compression ratio (C3)>>a mechanical expansion ratio (E3).

Further, the control phase α3 has the relationship θint>θcomp similarly to the first embodiment, and therefore can acquire a similar effect of improving the startability and reducing the exhaust gas harmful components to the first embodiment. Then, an intake stroke (LI3) from an exhaust top dead center position (Y′03) to the intake bottom dead center position (YC3) is relatively longer than a compression stroke (LC3) from the intake bottom dead center position (YC3) to a compression top dead center position (Y03).

This arrangement can increase the amount of introduced fresh air and thus enhance the charging efficiency due to the long intake stroke (LI3), thereby allowing the internal combustion engine to increase the combustion torque to thus improve start stability at the time of a cold start when the engine has high friction.

Further, an important point of the characteristic of the control phase α3 is that the compression top dead center position (Y03) is located at a lower position than the compression top dead center position (Y04) according to the first embodiment (the thin line), although the intake bottom dead center position (YC3) is located at a lower position than the intake bottom dead center position (YC4) according to the first embodiment (the thin line) and therefore a sufficiently high compression ratio can be secured due to that similarly to the first embodiment. Further, this compression top dead center position (Y03) is located at a lower position than the exhaust top dead center position (Y′03) in the control phase α3, and has a relationship “Y03<Y′03”. Due to this arrangement, the second embodiment can acquire a special effect of reducing the exhaust gas harmful components like an example that will be described below.

That is, a rise of the compression top dead center position also leads to a rise of the position of the piston crown surface, thereby leading to a reduction in a distance to a fuel injection valve disposed at an upper side in the combustion chamber. This makes it easy for a fuel spray injected from the fuel injection valve to be attached to the piston crown surface while being kept in the form of liquid droplets. When such fuel attached to the piston crown surface is ignited by an ignition plug and combusted, this fuel is easily incompletely combusted and easily creates uncombusted carbohydrates and/or particulate matters (PM), which is soot.

Unlike fuel liquid droplets atomized or being atomized in the space in the combustion chamber, the fuel attached to the crown surface is attached to the surface of the piston crown surface (metal) in the form of liquid droplets, and therefore is not in contact with the high-temperature air along an entire circumference of the liquid droplets, which makes it difficult to advance a combustion reaction on the piston crown surface side. Further, especially at the time of the start, the piston crown surface often has a low surface temperature, so that the fuel liquid droplets are cooled down and the combustion is deteriorated, which also facilities the emission of the uncombusted carbohydrates and/or particulate matters.

Then, the present embodiment sets the relatively low compression top dead center position (Y03), and therefore makes it difficult for the fuel spray to be attached to the piston crown surface. This allows the internal combustion engine to prevent or reduce the generation of uncombusted carbohydrates and/or particulate matters due to the attachment of the above-described fuel spray to the piston crown surface.

On the other hand, the following problem is raised when the internal combustion engine is restarted while being in the high-temperature state (so-called a hot restart). For example, suppose that the vehicle runs at a high speed on an expressway, and, after that, temporarily shuts down the internal combustion engine due to the idle reduction at a tool booth and restarts the internal combustion engine next. In this case, if the internal combustion engine is designed to use the high compression ratio, abnormal combustion called the pre-ignition (premature ignition) may occur and noise may be generated due to that at the time of the start.

Therefore, in the present embodiment, the piston stroke adjustment apparatus is configured to switch the characteristic to the characteristic of the control phase α2 in the case of such a start under the high temperature. As indicated by the alternate long and short dash line in FIG. 8, the piston stroke adjustment apparatus operates so as to raise the intake bottom dead center position (YC2) and lower the compression top dead center position (Y02). This operation leads to a reduction in a compression stroke (LC2) and further leads to an increase in a volume in the combustion chamber at the compression top dead center (V02). As a result, the internal combustion engine becomes able to reduce the mechanical compression ratio (C2) only by a sufficient value.

Due to this effect, the internal combustion engine can prevent or reduce the occurrence of the pre-ignition, which may be caused when the internal combustion engine is started at the time of the high temperature, thereby avoiding the start accompanied by the noise due to the abnormal combustion. Further, this operation also leads to a reduction in an intake stroke (L12), thereby leading to a reduction in the amount of introduced air-fuel mixture and thus a reduction in the charging efficiency, contributing to further avoiding the pre-ignition at the time of the start under the high temperature.

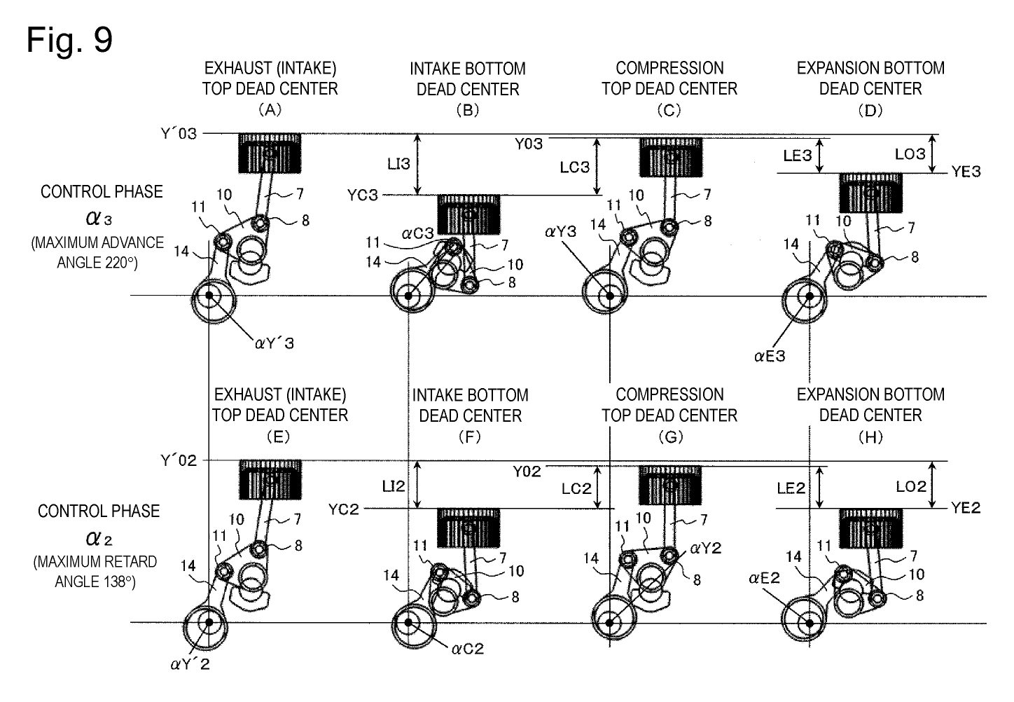

Next, a change in a mechanism posture in each stroke of the combustion cycle in each of the control phase α2 and the control phase α3 will be described with reference to FIGS. 9(A) to 9(H). FIGS. 9(A) to 9(D) lined up in an upper row illustrate the change in the mechanism posture in the control phase α3, and FIGS. 9(E) to 9(H) lined up in a lower row illustrate the change in the mechanism posture in the control phase α2. A characteristic of the change in the mechanical posture in the control phase α3 is substantially similar to the characteristic in the control phase α4 according to the first embodiment, but is different therefrom in terms of the compression top dead center position (Y03) located at a lower position than the exhaust (intake) top dead center position (Y′03).

<<Exhaust (Intake) Top Dead Center>>

First, the change in the mechanical posture will be discussed, focusing on the eccentricity direction (αY′) of the eccentric cam portion at the exhaust (intake) top dead center. In the control phase α3, as illustrated in FIG. 9(A), an eccentricity direction (αY′3) of the eccentric cam portion is oriented in a direction slightly separated from the control link 14 with the second coupling pin 11 slightly pulled down via the control link 14 and the lower link 10 slightly rotated in the counterclockwise direction, compared to the control phase α1 and the control phase α4. This posture causes the crankpin and the piston pin to be aligned further linearly therebetween, and the exhaust (intake) top dead center position (Y′03) of the piston to be displaced slightly to the upper side compared to the exhaust (intake) top dead center position (Y04) in the control phase α4.

In the control phase α2, as illustrated in FIG. 9(E), an eccentricity direction (αY′2) of the eccentric cam portion is oriented in a direction further separated from the control link 14, and the exhaust (intake) top dead center position (Y′02) of the piston is displaced slightly to the upper side compared to the exhaust (intake) top dead center position (Y′03) in the control phase α3.

<<Intake Bottom Dead Center>>

Next, the change in the mechanical posture will be discussed, focusing on an eccentricity direction (αC) of the eccentric cam portion at the intake bottom dead center. In the control phase α3, as illustrated in FIG. 9(B), an eccentricity direction (αC3) of the eccentric cam portion is oriented in the direction of the control link 14. Due to this posture, the control link 14 pushes up the second coupling pin 11 to the upper right, and the lower link 10 is rotated in the clockwise direction with the crankpin serving as a supporting point therefor. Due to this movement, the position of the first coupling pin 8 is lowered, and the piston 2 is pulled down by the upper link 7. As a result, the intake bottom dead center (YC3), which also corresponds to the compression start point, is placed at a relatively low position, and a long compression stroke (LC3) is acquired at this time.

On the other hand, in the control phase α2, as illustrated in FIG. 9(F), an eccentricity direction (αC2) of the eccentricity control cam is oriented in a direction approximately orthogonal to the control link 14, i.e., is located relatively in a direction further separated from the control link 14 compared to αC3 and αC4. Therefore, due to this posture, the control link 14 pulls down the second coupling pin 11 relatively to the lower left and the lower link 10 is rotated in the counterclockwise direction with the crankpin serving as a supporting point therefor, by which the position of the first coupling pin 8 is raised and the piston is pushed up by the upper link 7. As a result, the intake bottom dead center (YC2) is placed at a higher position than the intake bottom dead center position (YC3), which also corresponds to the compression start point, and a short compression stroke (LC2) is acquired at this time.

<<Compression Top Dead Center>>

Next, the change in the mechanical posture will be discussed, focusing on an eccentricity direction (αY) of the eccentric cam portion at the compression top dead center. In the control phase α3, as illustrated in FIG. 9(C), an eccentricity direction (αY3) of the eccentric cam portion is oriented in a direction approaching the control link 14 compared to (αY4), so that the second coupling pin 11 is slightly pulled down via the control link 14 and the lower link 10 is slightly rotated in the clockwise direction. Due to this posture, a line segment connecting the crankpin and the first coupling pin 8 and a line segment connecting the first coupling pin 8 and the piston pin are largely bent and arranged in a left dogleg-like shape, which causes the piston position (Y03) at the compression top dead center to be located at a lower position than the piston position (Y′03) at the exhaust top dead center and, further, located at a lower position than the piston position (Y04) at the compression top dead center in the control phase α4.

Regarding the descent of the piston position at the compression top dead center due to this left dogleg-like shape, the piston position can be significantly lowered by setting an offset K between a central line of the piston and a center of the crankshaft as illustrated in FIG. 1.

Next, a characteristic of the change in the mechanical posture in the control phase α2 is characterized in that the mechanical compression ratio can sufficiently reduce due to the rise of the intake bottom dead center position and the descent of the compression top dead center position.

In the control phase α2, as illustrated in FIG. 9(G), an eccentricity direction (αY2) of the eccentricity control cam is oriented in a direction close to the direction of the control link 14, i.e., is located in the direction approaching the control link 14 compared to αY3 and αY4. Due to this posture, the control link 14 pushes up the second coupling pin 11 relatively to the upper right, and the lower link 10 is rotated in the clockwise direction with the crankpin serving as a supporting point therefor, by which the position of the first coupling pin 8 is lowered and the piston is pulled down by the upper link 7. As a result, the compression top dead center position (Y02) is placed at a lower position than the compression top dead center position (Y03) in the control phase α3.

In the above-described manner, in the control phase α2 compared to the control phase α3, the intake bottom dead center position (YC2) is located at a higher position than the intake bottom dead center position (YC3), and the compression top dead center position (Y02) is located at a lower position than the compression top dead center position (Y03). Therefore, the control phase α2 leads to the short compression stroke (LC2) and further leads to the large volume in the combustion chamber (V02) at the compression top dead center (Y02), thereby resulting in the sufficient reduction in the mechanical compression ratio. Further, the control phase α2 also results in the reduction in the intake stroke (LI2).

In this manner, the piston position change characteristic in the control phase α2 illustrated in FIG. 8 is created based on the difference in the link posture due to the difference in the eccentricity phase of the control cam illustrated in FIGS. 9(A) to 9(H).

<<Expansion Bottom Dead Center>>

Next, the change in the mechanical posture will be discussed, focusing on an eccentricity direction (αE) of the eccentric cam portion at the expansion bottom dead center. In the control phase α2, as illustrated in FIG. 9(D), an eccentricity direction (αE3) of the eccentric cam portion is oriented to the opposite side from the direction of the control link 14. Due to this posture, the control link 14 pulls down the second coupling pin 11 to the lower left, and the lower link 10 is rotated in the counterclockwise direction with the crankpin serving as a supporting point therefor, by which the position of the first coupling pin 8 is raised and the piston is pushed up by the upper link 7. As a result, the expansion bottom dead center (YE3) is placed at a relatively high position, and a short expansion stroke (LE3) is acquired at this time.

In the control phase α2, as illustrated in FIG. 9(H), an eccentricity direction (αY2) of the eccentricity control cam is oriented in the direction approaching the control link 14 compared to (αE3), so that the control link 14 pushes up the second coupling pin 11 to the upper right, and the lower link 10 is rotated in the clockwise direction with the crankpin serving as a supporting point therefor, by which the position of the first coupling pin 8 is lowered and the piston is pulled down by the upper link 7. As a result, the expansion bottom dead center (YE2) is placed at a lower position than the expansion bottom dead center position (YE3), and a slightly longer expansion stroke (LE2) than the control phase α3 is acquired at this time. This causes the expansion stroke (LE) to have the relationship “LE2>>LE3”.

In this manner, the characteristic illustrated in FIG. 8 is established, as the control phase α3 has the relationship “YC3>>YE3” and the control phase α2 has the relationship “YE2≅YC2”.

Then, the characteristic of the control phase α3 has the intake bottom dead center position (YC3) considerably lower than the expansion bottom dead center (YE3), and exhibits the relationship of the mechanical compression ratio (C3)>>the mechanical expansion ratio (E3). Therefore, the second embodiment can bring about similar functions and effects to the first embodiment.

Further, the compression top dead center position (Y03) is set to a lower position than the compression top dead center position (Y04) according to the first embodiment. Further, this compression top dead center position (Y03) is located at a lower position than the exhaust top dead center position (Y′03) in this control phase α3, and has a relationship “Y03<Y′03”.

A rise of the compression top dead center position also leads to a rise of the position of the piston crown surface, thereby leading to a reduction in the distance to the fuel injection valve disposed at the upper side in the combustion chamber. This makes it easy for the fuel spray injected from the fuel injection valve to be attached to the piston crown surface while being kept in the form of liquid droplets. When such fuel attached to the piston crown surface is ignited by the ignition plug and combusted, this fuel is easily incompletely combusted and easily creates uncombusted carbohydrates and/or particulate matters (PM), which is soot.

The present embodiment sets the relatively low compression top dead center position (Y03), and therefore makes it difficult for the fuel spray to be attached to the piston crown surface. This allows the internal combustion engine to prevent or reduce the generation of uncombusted carbohydrates and/or particulate matters due to the attachment of the above-described fuel spray to the piston crown surface.

Further, according to the characteristic of the control phase α2, the piston stroke adjustment apparatus operates so as to raise the intake bottom dead center position (YC2) and lower the compression top dead center position (Y02) compared to the control phase α3. This operation leads to the reduction in the compression stroke (LC2) and further leads to the increase in the volume in the combustion chamber at the compression top dead center (V02). As a result, the internal combustion engine becomes able to reduce the mechanical compression ratio (C2) only by a sufficient value. Due to this effect, the internal combustion engine can prevent or reduce the occurrence of the pre-ignition, which may be caused when the internal combustion engine is started at the time of the high temperature, thereby avoiding the start accompanied by the noise due to the abnormal combustion. Further, this operation also leads to the reduction in the intake stroke (LI2), thereby leading to the reduction in the amount of introduced air-fuel mixture and thus the reduction in the charging efficiency, contributing to further avoiding the pre-ignition at the time of the start under the high temperature.

Switching between the control phase α2 and the control phase α3 can be achieved basically by detecting a temperature of the internal combustion engine (for example, a temperature of cooling water), and employing the control phase α2 if determining that the detected temperature is the high-temperature state while employing the control phase α3 if determining that the detected temperature is not the high temperature.

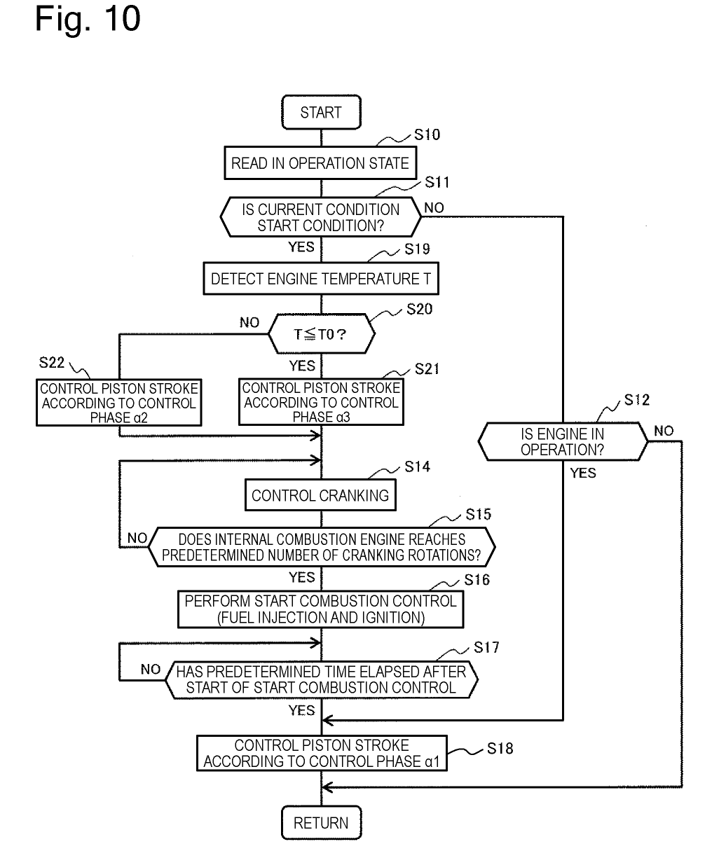

Next, specific control corresponding to the operation state using the above-described piston stroke adjustment apparatus will be described with reference to FIG. 10.

First, in step S10, the piston stroke adjustment apparatus reads in various kinds of operation information including the start state as the current operation state of the engine. Next, in step S11, the piston stroke adjustment apparatus determines whether the current condition is the start condition. The start condition can be determined from the driver's key switch operation, the pressing of the accelerator, or the like.

If determining that the current state is not the start state (the start condition) in step S11, in step S12, the piston stroke adjustment apparatus determines whether the internal combustion engine is in operation. If the piston stroke adjustment apparatus determines that the internal combustion engine is not in operation, the processing proceeds to RETURN and this control is ended. On the other hand, if determining that the internal combustion engine is in operation, the piston stroke adjustment apparatus determines that the current state is the normal operation state after the warm-up is ended. Then, the processing proceeds to step S18, in which the piston stroke adjustment apparatus adjusts the piston stroke according to the control phase α1.

If determining that the current state is the start state in step S11, the processing proceeds to step S19, in which the piston stroke adjustment apparatus detects a temperature T of the internal combustion engine. The temperature of the cooling water of the internal combustion engine can be used as this temperature. After the detection of the temperature of the internal combustion engine, the processing proceeds to step S20, in which the piston stroke adjustment apparatus determines whether the detected temperature T is lower than a predetermined temperature T0.

If the detected temperature T is the predetermined temperature T0 or lower in step S20, the processing proceeds to step S21 assuming that the current state is the cold start or the normal state. In step S21, the piston stroke adjustment apparatus adjusts the piston stroke according to the control phase α3 suitable for the cold start or the normal start.

On the other hand, if the detected temperature T detected is higher than the predetermined temperature T0 in step S20, the processing proceeds to step S22 assuming that the current state is the hot start (the high-temperature state). This hot start corresponds to, for example, a start when the vehicle runs at a high speed on an expressway, and, after that, temporarily shuts down the internal combustion engine due to the idle reduction at a tool booth and restarts the internal combustion engine next. In step S22, the piston stroke adjustment apparatus adjusts the piston stroke according to the control phase α2 suitable for the hot start.

Upon an end of the setting of the control phase α3 or the control phase α2 in step S21 or S22, in step S14, the piston stroke adjustment apparatus cranks and starts the internal combustion engine. After that, the processing proceeds to step S15, in which the piston stroke adjustment apparatus determines whether the internal combustion engine reaches the predetermined number of cranking rotations. If the internal combustion engine does not reach the predetermined number of cranking rotations, the processing returns to step S14 again, in which the piston stroke adjustment apparatus continues the cranking. If the internal combustion engine exceeds the predetermined number of cranking rotations, the processing proceeds to step S16.

In step S16, the piston stroke adjustment apparatus performs the start combustion control such as the fuel injection control and the ignition control. After that, the processing proceeds to step S17. In step S17, the piston stroke adjustment apparatus determines whether the predetermined time has elapsed from the start of the start combustion control. This determination is the determination about whether the internal combustion engine is warmed up. If the predetermined time has not elapsed, the piston stroke adjustment apparatus performs this determination processing again. If the predetermined time has elapsed, the piston stroke adjustment apparatus determines that the internal combustion engine is warmed up, and then the processing proceeds to step S18.

The flowchart may be configured in such a manner that, when the hot start is carried out in step S22, the processing may proceed to step S18 without performing step S17. In this case, the intended result can be achieved by setting a flag “1” indicating that the employed control phase is the control phase α2 in step S22, preparing a control step for monitoring this flag “1” between step S16 and step S17, and determining that the current state is the hot start and then causing the processing to proceed to step S18 if the flag “1” is set.

Step S18 is set in such a manner that the piston stroke adjustment apparatus switches the control from control according to the control phase α2 or the control phase α3 to the control according to the control phase α1, thus performing the control for the normal operation state, and then the processing proceeds to RETURN.

In this manner, according to the present embodiment, functions and effects like examples that will be described below can be brought about, besides the functions and the effects according to the first embodiment.

The control phase α3 according to the present embodiment has the relatively low compression top dead center position (Y03) compared to the first embodiment, and therefore makes it difficult for the fuel spray to be attached to the piston crown surface. This allows the internal combustion engine to prevent or reduce the generation of uncombusted carbohydrates and/or particulate matters due to the attachment of the above-described fuel spray to the piston crown surface.

Further, in the control phase α2, the piston stroke adjustment apparatus operates so as to raise the intake bottom dead center position (YC2) and lower the compression top dead center position (Y02) compared to the control phase α3. As a result, the internal combustion engine becomes able to reduce the mechanical compression ratio (C2) only by a sufficient value. Due to this effect, the internal combustion engine can prevent or reduce the occurrence of the pre-ignition, which may be caused when the internal combustion engine is started at the time of the high temperature, thereby avoiding the start accompanied by the noise due to the abnormal combustion.

The above-described embodiments have been described based on a single-cylinder internal combustion engine, but, obviously, the present invention can be applied to a multi-cylinder internal combustion engine, such as a two-cylinder internal combustion engine, a three-cylinder internal combustion engine, a four-cylinder internal combustion engine, and a six-cylinder internal combustion engine. In this case, piston operation characteristics of all of the cylinders can be adjusted by a single piston stroke adjustment apparatus if the internal combustion engine is an inline engine or a piston operation characteristic for each bank can be adjusted by a pair of piston stroke adjustment apparatuses if the internal combustion engine is a V-type engine, and they allow all of the cylinders to be controlled to a desired mechanical compression ratio and a desired mechanical expansion ratio.

Further, as the piston position change mechanism described in the embodiments, another appropriate piston position change mechanism can be employed within a range that does not depart from the spirit of the present invention. For example, the present embodiments have been described based on the example in which the pair of reduction gear pulleys is employed as the speed reduction mechanism that transmits the rotation of the crankshaft to the eccentric cam while slowing down this rotation to the half angular speed, but the present invention is not limited thereto.

Further, in the present embodiments, the crankshaft and the eccentric cam are rotated in opposite directions from each other, but may be rotated in the same direction as each other. For example, each of the embodiments may be configured to transmit the rotation of the pulley on the crank side to the pulley on the eccentric control cam side while slowing down this rotation to the half angular speed via a timing belt (a timing chain). In this case, the crankshaft and the eccentric control cam are rotated in the same direction as each other and the piston position change characteristic (the vertical axis) with respect to the rotation of the crankshaft (the horizontal axis) is horizontally inverted, but the operation itself remains the same.

Further, the link mechanism used in the piston position change mechanism is not limited to the specific example described in the embodiments, and may be a different link mechanism as long as this link mechanism is a mechanism capable of changing the characteristic of the stroke position of the piston in a similar manner.

In the above-described manner, the present invention is configured to increase the mechanical compression ratio during the compression stroke to thus increase the temperature of the air-fuel mixture at the compression top dead center, and reduce the mechanical expansion ratio during the expansion stroke to thus prevent or cut down the reduction in the temperature of the exhaust gas at the expansion bottom dead center, at the time of the start of the internal combustion engine.

According to this configuration, the present invention allows the internal combustion engine to increase the temperature of the air-fuel mixture at the compression top dead center to thus improve and stabilize the combustion, and, further, prevent or cut down the reduction in the temperature of the exhaust gas at the expansion bottom dead center. Due to this effect, the present invention allows the internal combustion engine to improve the startability thereof and also reduce the emission amount of exhaust harmful components.

The present invention is not limited to the above-described embodiments, and includes various modifications. For example, the above-described embodiments have been described in detail to facilitate better understanding of the present invention, and are not necessarily limited to the configurations including all of the described features. Further, a part of the configuration of some embodiment can be replaced with the configuration of another embodiment. Further, some embodiment can also be implemented with a configuration of another embodiment added to the configuration of this embodiment. Further, each of the embodiments can also be implemented with another configuration added, deleted, or replaced with respect to a part of the configuration of this embodiment.

The present application claims priority under the Paris Convention to Japanese Patent Application No. 2015-251421 filed on Dec. 24, 2015. The entire disclosure of Japanese Patent Application No. 2015-251421 filed on Dec. 24, 2015 including the specification, the claims, the drawings, and the abstract is incorporated herein by reference in its entirety.

### REFERENCE SIGN LIST

01 internal combustion engine
02 cylinder block
03 bore
1 piston position variable mechanism
2 piston
3 piston pin
4 crankshaft
5 link mechanism
6 phase change mechanism
7 upper link (first link)
8 first coupling pin
9 crankpin
10 lower link (second link)
11 second coupling pin
12 control shaft
13 eccentric cam portion
14 control link (third link)
15 first gear wheel (driving rotational member)
16 second gear wheel (drive rotational member)

1. A piston stroke adjustment apparatus for an internal combustion engine, comprising:
a piston position change mechanism capable of changing a mechanical compression ratio and a mechanical expansion ratio by changing a stroke position of a piston in a four-cycle internal combustion engine; and
a control unit configured to set the mechanical compression ratio to a high ratio relative to the mechanical expansion ratio and set the mechanical expansion ratio to a low ratio relative to the mechanical compression ratio by the piston position change mechanism at the time of a start of the internal combustion engine.

2. The piston stroke adjustment apparatus for the internal combustion engine according to claim 1, wherein the control unit sets a relatively long period as a period during which fresh air is introduced and sets a relatively short period as a period during which the fresh air is compressed at the time of the start of the internal combustion engine by the piston position change mechanism.

3. The piston stroke adjustment apparatus for the internal combustion engine according to claim 1, wherein the control unit sets the position of the piston at a compression top dead center to a low position relative to the position of the piston at an exhaust top dead center at the time of the start of the internal combustion engine by the piston stroke change mechanism.

4. The piston stroke adjustment apparatus for the internal combustion engine according to claim 1, wherein the control unit sets an intake stroke to a long stroke relative to a compression stroke at the time of the start of the internal combustion engine by the piston stroke change mechanism.

5. The piston stroke adjustment apparatus for the internal combustion engine according to claim 1, wherein, if a temperature of the internal combustion engine exceeds a predetermined temperature, the control unit sets the mechanical compression ratio to a low ratio relative to the mechanical compression ratio that is set at the time of the start when the temperature of the internal combustion engine is the predetermined temperature or lower, at the time of the start of the internal combustion engine by the piston position adjustment mechanism.

6. The piston stroke adjustment apparatus for the internal combustion engine according to claim 1, wherein the control unit sets the mechanical compression ratio to a relatively high ratio and the mechanical expansion ratio to a relatively low ratio if a temperature of the internal combustion engine is a predetermined temperature or lower, and sets the mechanical compression ratio to a low ratio relative to the mechanical compression ratio that is set when the temperature of the internal combustion engine is the predetermined temperature or lower if the temperature of the internal combustion engine exceeds the predetermined temperature after that, at the time of the start of the internal combustion engine by the piston position change mechanism.

7. The piston stroke adjustment apparatus for the internal combustion engine according to claim 1, wherein the internal combustion engine is configured in such a manner that a central axis of the piston is spaced apart by a predetermined amount from a rotational central axis of a crankshaft, and
wherein the piston position change mechanism includes
a first link having one end coupled with the piston via a piston pin,
a second link rotatably coupled with an opposite end of the first link via a first coupling pin and also rotatably coupled with the crankshaft,
a control shaft configured to rotate at an angular speed that is half of an angular speed of the crankshaft,
an eccentric axis portion provided on the control shaft and disposed eccentrically with respect to the rotational central axis of the control shaft,
a third link having one end coupled with the second link via a second coupling pin and an opposite end rotatably coupled with the eccentric axis portion, and
a link posture mechanism capable of changing an eccentricity direction of the eccentric axis portion with respect to the central axis of the control shaft.

8. The piston stroke adjustment apparatus for the internal combustion engine according to claim 7, wherein the control shaft is provided at an opposite side of the central axis of the crankshaft from the central axis of the piston.

9. A piston stroke adjustment apparatus for an internal combustion engine, the internal combustion engine including a piston position change mechanism, the piston position change mechanism being capable of changing a mechanical compression ratio and a mechanical expansion ratio by changing a stroke position of a piston having a central axis that is offset from a rotational central axis of a crankshaft by a predetermined amount in a four-cycle internal combustion engine,
wherein the piston position change mechanism includes
a first link having one end coupled with the piston via a piston pin,
a second link rotatably coupled with an opposite end of the first link via a first coupling pin and rotatably coupled with the crankshaft,
a control shaft configured to rotate at an angular speed that is half of an angular speed of the crankshaft,
an eccentric axis portion provided on the control shaft and disposed eccentrically with respect to the rotational central axis of the control shaft,
a third link having one end coupled with the second link via a second coupling pin and an opposite end rotatably coupled with the eccentric axis portion,
a link posture change mechanism capable of changing an eccentricity direction of the eccentric axis portion with respect to the central axis of the control shaft, and
a control unit configured to set the link posture change mechanism at the time of a start of the internal combustion engine in such a manner that a central axis of the eccentric axis portion at an intake bottom dead center is located at the second coupling pin side with respect to the central axis of the control shaft, and
the control unit also configured to set the link posture change mechanism at the time of the start of the internal combustion engine to a first position at which the central axis of the eccentric axis portion at an expansion bottom dead center is located at an opposite side of the central axis of the control shaft from the second coupling pin.

10. The piston stroke adjustment apparatus for the internal combustion engine according to claim 9, wherein the control unit sets the link posture change mechanism so as to cause the central axis of the eccentric axis portion at the intake bottom dead center to be located at the opposite side of the central axis of the control shaft from the second coupling pin, and cause the central axis of the eccentric axis portion at the expansion bottom dead center to be located at the second coupling pin side with respect to the central axis of the control shaft, by the link posture change mechanism when a temperature of the internal combustion engine is higher than a predetermined temperature.
